(19) United States
(12) Patent Application Publication
(10) Pub. No.: US 2002/0129628 A1
(43) Pub. Date: Sep. 19, 2002

(54) Luggage, baggage and package security device

(76) Inventor: Roy Skalberg, Davie, FL (US)

Correspondence Address: David P. Lhota, Stearns Weaver Miller, et al., Suite 1900, 200 East Broward Boulevard, Fort Lauderdale, FL, 33301, US

(21) Appl. No.: 10/086,998

(22) Filed: Mar. 1, 2002

Related U.S. Application Data
(60) Provisional application No. 60/272,574, filed on Mar. 1, 2001.

(51) Int. Cl. E05B 73/00

(52) U.S. Cl. 70/18

(57) ABSTRACT

A luggage, baggage and package security device having a lock box and nylon, steel reinforced strap that is wrapped around a container, preferably through its handles, if any, and adjustably and securely drawn into the lock box and locked to prevent unwanted removal. The lock box comprises a rotatable spindle, handle, spindle ratchets, ratchet sprocket, spring-loaded pawl, spindle release button, lock, zipper tab security receptacle and buckle release button. The strap preferably comprises a durable, nylon woven, steel reinforced strap. The steel reinforcement is preferably braided. The strap is wrapped around a suitcase, package, travel bag or gym bag, drawn inward around the spindle by turning the spindle handle in the appropriate direction and locked therein to prevent the container from being opened without first unlocking the device.

### CROSS REFERENCE TO RELATED APPLICATIONS

This application claims the benefit of Provisional Application Serial No. 60/272,574 filed Mar. 1, 2001.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to a baggage and package lock, and more particularly, to a baggage and package lock that fits through handles and around packages and baggage, such as suitcases, travel bags and gym bags, to prevent them from being opened without authorization or without unlocking the device.

2. Description of the Background Art

The security of luggage, baggage or packages is often compromised. It is well known that airport personnel sometimes open and access luggage, baggage or packages. Other persons having access to these items are also candidates for theft. While conventional luggage and baggage have locks, these locks are weak and easily bypassed. Accordingly, there exists a need for a security device that is adapted to secure luggage, baggage and packages to prevent unauthorized entry and theft of the contents therein. It would be a further benefit to have a security device that monitors attempted breaches of the security device. The instant invention solves the above-noted problems.

### BRIEF SUMMARY OF THE INVENTION

Based on the foregoing, it is a primary object of the instant invention to provide a security device for adapted for universally securing luggage, baggage and, or packages.

It is another object of the instant invention to provide a mechanical security device that fits around suitcases, travel bags and gym bags to prevent them from being opened without first unlocking the device.

It is also an object of the instant invention to provide a mechanical security device that fits through the handles of suitcases, travel bags and gym bags to prevent them from being opened without first unlocking the device.

It is an additional object of the instant invention to provide a mechanical device that will fit around packages to protect them from being opened without unlocking the device or entering the package without leaving a visible sign of entry.

It is a further object of the instant invention to provide a mechanical device that conceals and secures zipper tabs on luggage to prevent access thereto.

It is yet another object of the instant invention to provide a low cost, secure and simple method of protecting the contents of suitcases, packages, travel bags or gym bags from theft

It is also an object of the instant invention to provide a luggage, baggage and package device that is amenable to low-cost, efficient and convenient construction.

In light of these and other objects, the instant invention provides a luggage, baggage and package security device, generally referenced herein as a container security device, comprising a lock box and nylon, steel reinforced strap that is wrapped around a container, preferably through its handles, if any, and adjustably and securely drawn into the lock box and locked to prevent unwanted removal. The lock box comprises a rotatable spindle, handle, spindle ratchets, ratchet sprocket, spring-loaded pawl, spindle release button, lock, zipper tab security receptacle and buckle release button. The strap preferably comprises a durable, nylon woven, steel reinforced strap. The steel reinforcement is preferably braided and cannot be cut with conventional tools. The strap is wrapped around a suitcase, package, travel bag or gym bag, drawn inward around the spindle by turning the spindle handle in the appropriate direction and locked therein to prevent the container from being opened without first unlocking the device. When the container security device is properly locked, the only way to access the container is by compromising the integrity of the container, such as by cutting through the container. The strap is steel reinforced and sufficiently durable to be resistive to cutting with standard tools.

In an alternative embodiment, the container security device may include an alarm, sounding device and, or time and date recorder (generally referenced as a signaling device, to indicate if and when there are any attempts to enter the container or breach the container security device.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a top elevational and partial cut-away view of the preferred embodiment of the security container device in accordance with the instant invention.

FIG. 2 is a top elevational view of the preferred embodiment of the security container strap in accordance with the instant invention.

FIG. 3 is a top elevational and partial cut-away view of the preferred embodiment of the security container device in accordance with the instant invention.

FIG. 4 is a side elevational view of the preferred embodiment of the security container device in accordance with the instant invention illustrating the zipper tabreceiving receptacle in phantom.

FIG. 5 is a top elevational and partial cross-sectional view of the security container device in accordance with the instant invention.

### DETAILED DESCRIPTION OF THE INVENTION

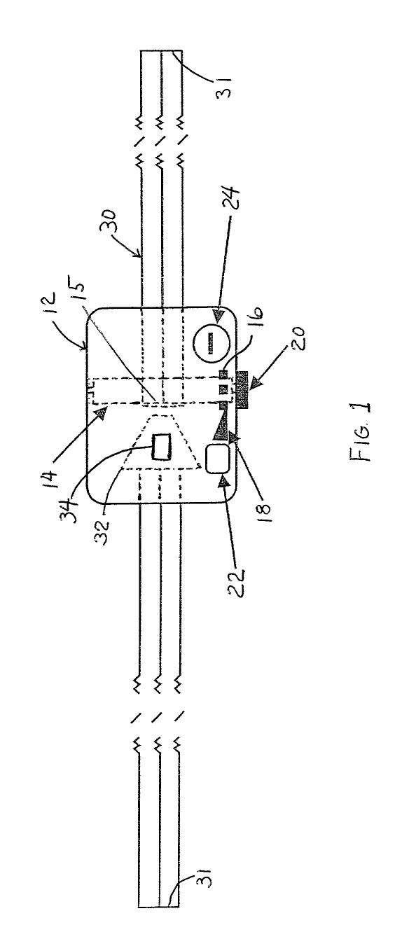

With reference to the drawings, FIGS. 1-5 depict the preferred and alternative embodiments of the instant invention, which is generally characterized as a container security device and, or by reference numeral 10. The container security device 10 secures luggage, baggage and packages from unauthorized opening and comprises a lock box 12 and strap 30 that adjustably interlocks with the lock box 12. The lock box 12 is adapted for securely receiving, holding and locking the strap 30 therein. The invention is a locking box-type device designed to accept a strap, which is temporarily wrapped through the handles and around a suitcase, package, travel bag or gym bag. The purpose of the device 10 is to protect the contents from theft by preventing the container from being opened without first removing the device 10. Entry into the container without unlocking the device requires compromising the integrity of the package being secured.

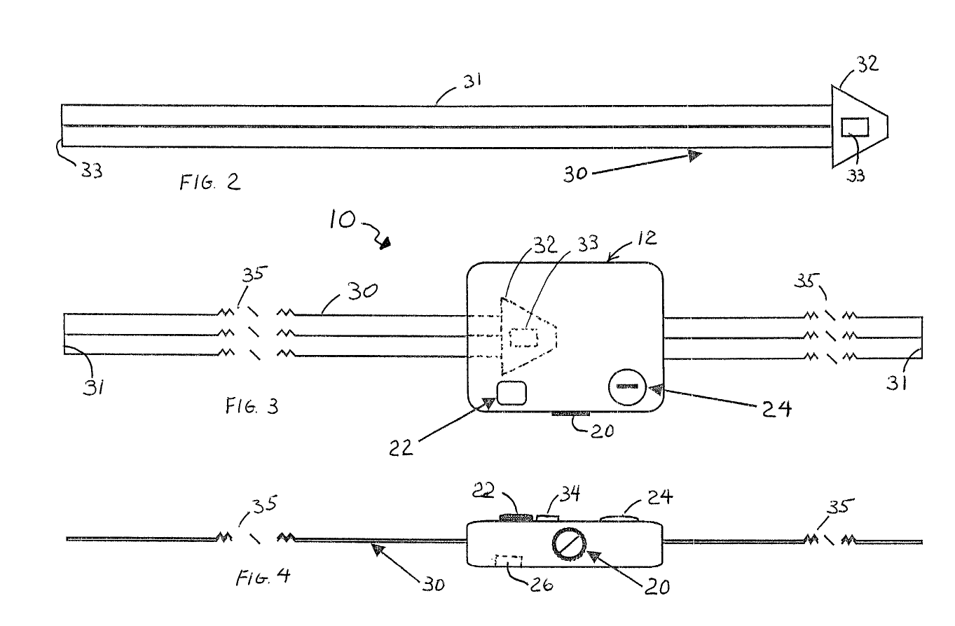

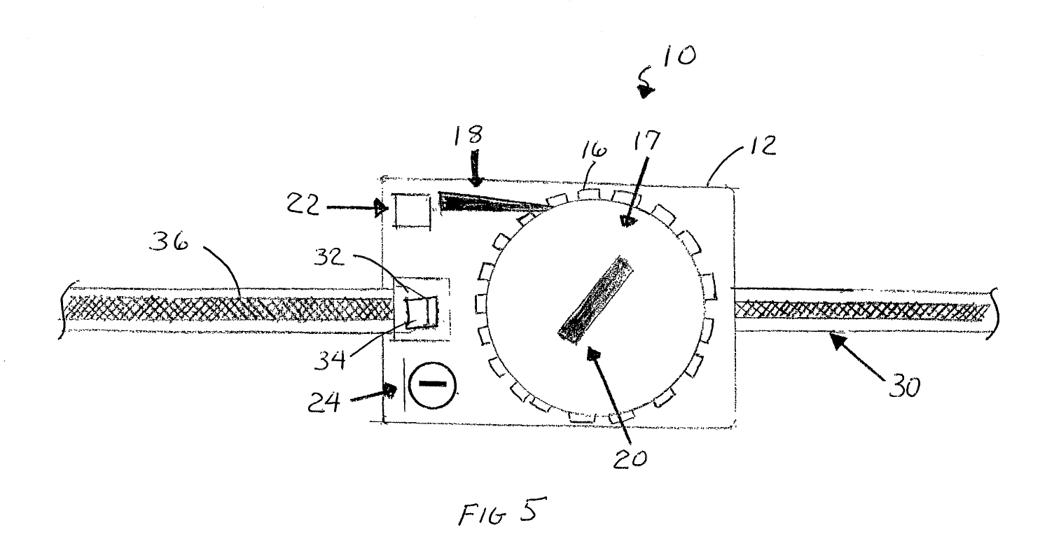

With reference to FIGS. 1 and 3-5, the lock box 12 comprises a rotatable spindle 14, handle 20, spindle ratchets 16, ratchet sprocket 17, spring-loaded pawl 18, spindle release button 22, lock 24, zipper tab security receptacle 26 and buckle release button 34. Referring to FIG. 5, the ratchets 16 may project radially from a sprocket 17, which is integral with or permanently affixed to the spindle 14. With reference to FIGS. 2 and 5, the strap 30 preferably comprises a durable, nylon woven, steel reinforced strap 36. The steel reinforcement 36 is preferably braided to enhance the strength of the strap 36 to prevent or make it more difficult to cut it with conventional tools. The spindle 14 and strap 30 are locked in place by the lock 24 and pawl 18 to prevent the strap 30 from unwinding from the spindle 30 and the container from being opened without first unlocking the device. The strap 36 is wrapped around a suitcase, package, travel bag or gym bag, and drawn inwardly around the spindle 14 by turning the spindle handle 20 in the appropriate direction. The lock box 12 includes a slot adapted for interlocking with the strap 30. The purpose of the device is to protect the contents from theft by preventing the container from being opened without first removing the container security device 10. When the container security device 10 is properly locked, the only way to access the container is by compromising the integrity of the container, such as by cutting through the container.

With reference to FIGS. 1-5, the lock box 12 securely holds one end 33 of the strap 30 at one end and receives the strap buckle 32 through a slot at the opposite end. The spindle 14 is rotatably secured inside the lock box 12 and securely holds one end of the strap 30. The strap 30 is permanently affixed at a fixed end 33 to the spindle 14 by a strap retainer 15. The strap retainer 15 may comprise a narrowed slot, closeable slot, hardware or adhesives that securely and essentially permanently hold the non-buckle end of the strap 30. The opposite end of the strap 30 is fitted with a tapered buckle 32 for smoothly entering a corresponding slot preferably found on the opposite end of the lock box 12 and adapted for securely receiving the buckle 32. The buckle 32 includes an aperture 33 for engaging and disengaging the buckle release button 34 in a way that is similar to conventional seat belts found in automobiles. The release button 34 is preferably spring-loaded for automatically engaging the buckle aperture 33 when the buckle is inserted into the lock box 12 and for releasing the buckle 32 when the buckle release button 34 is depressed.

When the buckle 32 is locked in place, the strap 30 is tightened around the luggage, baggage or package by rotating the spindle 14. The handle 20 preferably comprises a wheel-like structure that is mechanically joined to the spindle 14 for transferring rotational movement of the handle 20 to rotational movement of the spindle 14. The handle 20 may also comprise a knob or other structure to facilitate a firm grip. The spindle 14 includes a plurality of ratchets 16 that are engaged by the spring-loaded pawl 18 found inside the lock box 12. When engaged, the ratchets 16 and pawl 18 limit rotation of the spindle in one direction and prevent unwanted backwards rotation for drawing the strap 30 into the lock box 12. The spindle release button 22 comprises a spring-loaded button that releases the pawl 18 from the ratchets 16 to facilitate the release or unwinding of the strap 30 from the spindle 14 when the container security device 10 needs to be removed from the secured container. The spindle 14 includes an axis that is rotatably connected to the interior surface of the lock box 12 to facilitate rotation. The lock 24 preferably locks the pawl 18 and, or spindle 14 to prevent the pawl 18 from being released from the ratchets 16.

The device 10 is preferably equipped with a key operated lock 24. The lock 24 may also comprise a mechanical combination lock or an electronic lock. Electronic locks may not be appropriate in certain instances because they could interfere with security scanning equipment at airport terminals or may be mistaken as electronic components of contraband. The locking mechanism 24 secures one end of the strap 30 while at the same time preventing the ratcheting wheel 16 and, or spindle 14 from being rotated in a direction that loosens the strap 30.

With reference to FIGS. 1, 3 and 4, the strap 30 is fixed at one end to the spindle 14 and fitted with a buckle 32 at the opposite end. The buckle 32 includes a slot 33 for engaging and disengaging the spring-loaded buckle release button 34 when locking and unlocking, respectively, the buckle 32 inside the lock box 12. The mid-section of the strap 30 is depicted by reference numeral 31. The adjustable length of the strap 30 is depicted by reference numeral 35.

With reference to FIG. 4, the lock box 12 further includes a zipper tab security receptacle 26, which secures the zipper tabs on luggage or baggage having zippers. When the zipper is completely closed, the tabs fit inside the receptacle 26. By tightening the strap 30 inside the lock box 12, the zipper tabs become tightly secured inside the zipper tab receptacle 26. This prevents the container security device 10 from being bypassed by unzipping the luggage or baggage.

The security device 10 functions by placing one end of the strap 30 through a slot in the side of the lock box 12 and rotating the ratcheted spindle 14 to cause the strap 30 to become wrapped around the spindle 14. For best performance, the strap 30 is wrapped around a suitcase, package, travel bag or gym bag and through the handles, if any, available on the container. The buckle 32 is then inserted into the lock box 12, as above noted. The pawl 18 prevents the ratcheted spindle 14 from being rotated in the direction counter to tightening of the strap 30 while at the same time preventing the buckle from being released from lock box 12.

Straps 30 of various lengths may be provided to replace straps 30 damaged through usage, attempted break-ins and when a shorter or longer strap 30 is desired to accommodate packages of differing girth. All straps 30 are fitted with a buckle 32 swaged or tapered at one end and finished at the other end.

The lock box 12 may be painted, plated, coated by anodizing or powder coated to provide a finish which will be easily noticeable and durable. The purpose of producing such a noticeable finish will be to inform rapidly a potential thief that the suitcase, package or bag is sealed with a security device 10 and to encourage the potential thief to look elsewhere for an easier target.

The lock box 12 is preferably made from high impact plastic, cast, machined or sheet metal. The ratcheted spindle 14, pawl 18, buckle 32 and lock 24 may also comprise a hardened steel. The locking mechanism 24 preferably acts by moving a steel cam into the spindle 14 or ratchets 16 to prevent rotation of the spindle 14 and, or into the buckle release button 34 to prevent it from being depressed. The lock 24 may also comprise a steel cam that prevents the pawl 18 from being retracted from the ratchets 16 so as to prevent the spindle 14 from rotating.

The strap 30 is preferably made from materials that are strong, lightweight and flexible. It is suggested that the strap 30 be made from an outer layer of nylon or polypropylene with a steel flat braided inner wire section 36, as shown in FIG. 5. The polymer materials provide strength and flexibility while the steel flat braided wire prevents the strap 30 from being cut with common cutting tools like a knife or sharp edge.

The container security device 10 may be manufactured with an alarm, signaling device or time/date recorder to indicate when and if the lock box 12 is compromised or tampered. An electronic circuit used in this manner must be carefully constructed so as to cause no false indications in airport security scans when the article and locking mechanism 10 subjected to non-destructive testing, such as with x-rays or ultrasonic machines. The electronic circuitry used in an alarm or indicator must not produce interference with navigational or communications equipment used on aircraft. Any electronic circuitry for an alarm or locking mechanism is mounted on one or more circuit boards and these boards are mounted within the lock box 12. A battery to provide power for any electronic device(s) will also be mounted within the lock box housing 12. Lights or other alarm devices will also be mounted within the housing 12 such that the housing will securely contain all components of the security device.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. A luggage, baggage and security device for securely locking such a container closed, said device comprising:
a housing having a first slot and a second slot;
a spindle rotatably mounted inside said housing;
a strap secured at one end to said spindle and extending out of said first slot, said strap having a second end fitted with a fastener and adapted for insertion into said second slot;
a corresponding fastener adapter secured in said housing for releasably holding said fastener;
means, in mechanical communication with said fastener adapter, for releasably securing said fastener in said fastener adapter;
fastener locking means, in mechanical communication with said releasable locking means, for locking said fastener in said fastener adapter;
means, in mechanical communication with said spindle, for rotating said spindle;
means, in mechanical communication with said spindle, for facilitating rotation of said spindle in only one direction;

2. A device as recited in claim 1, wherein said releasable fastener securing means comprises:
a spring loaded tab engageable with an aperture defined in said fastener.

3. A device as recited in claim 2, wherein said fastener locking means comprises:
retractable cam lock for engaging said spring loaded tab when locked.

4. A device as recited in claim 3, wherein said cam comprises steel.

5. A device as recited in claim 1, wherein said spindle rotating means comprises a handle connected to said spindle.

6. A device as recited in claim 1, wherein said means for facilitating spindle rotation in one direction comprises:
a plurality of ratchets in mechanical communication with said spindle; and
a spring loaded pawl for engaging and disengaging said ratchets as said spindle rotates in one direction and for substantially permanently engaging said ratchets as said spindle attempts to rotate in an opposite direction.

7. A device as recited in claim 1, wherein said strap comprises a nylon woven material having a steel belted insert for durability and strength.

8. A device as recited in claim 7, wherein steel belted insert is braided for durability and strength.

9. A device as recited in claim 1, wherein said housing comprises a high impact and durable plastic material.

10. A device as recited in claim 1, wherein said housing comprises a high impact and durable steel cast material.

11. A device as recited in claim 1, wherein said device further comprises:
an alarm, signaling device for indicating when a suspect tampers with said device.

12. A device as recited in claim 1, wherein said device further comprises:
alarm, signaling device for indicating the time and date of when a suspect tampers with said device.

13. A device as recited in claim 1, wherein said buckle comprises a tapered contour for facilitating insertion into said second slot.

14. A device as recited in claim 1, wherein said housing is coated with a visible coating for visibly deterring tampering.

15. A device as recited in claim 6, wherein said device further comprises:
a release button in mechanical communication with said pawl for releasing said pawl from said ratchets to facilitate rotation of said spindle in both directions.
